(19) United States
(12) Patent Application Publication
(10) Pub. No.: US 2008/0086765 A1
(43) Pub. Date: Apr. 10, 2008

(54) ISSUANCE PRIVACY

(75) Inventors: Darrell J. Cannon, Sammamish, WA (US); Melissa W. Dunn, Woodinville, WA (US); Christopher G. Kaler, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/538,902

(22) Filed: Oct. 5, 2006

(51) Int. Cl. H04L 9/32

(52) U.S. Cl. 726/9

(57) ABSTRACT

Sending potentially sensitive information with privacy expectations. A method may be practiced, for example, in a computing environment. The method includes sending potentially sensitive information. Privacy expectation information is also sent specifying how the potentially sensitive information should be protected. The information and privacy expectation information may be included in an issued token, such that the privacy expectations can be later conveyed in a token exchange.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Modern computers often include functionality for connecting to other computers. For example, a modern home computer may include a modem for dial-up connection to internet service provider servers, email servers, directly to other computers, etc. In addition, nearly all home computers come equipped with a network interface port such as an RJ-45 Ethernet port complying with IEE 802.3 standards. This network port, as well as other connections such as various wireless and hardwired connections can be used to interconnect computers.

Often, when a client communicates with a service, the service has a published privacy policy that the client must accept, or inherently accepts if the client chooses to communicate with the service. For example, the service may have certain policies on what data sent from the client will be used for, who data sent from the client will be shared with, etc. These privacy policies are generally published such that the client can choose whether to accept a given policy or not. However, these policies are somewhat rigid in their application in that a client cannot negotiate policy, but is rather constrained to the published policy.

Additionally, services can change their policy. While generally there are notification requirements when policies change, it can be difficult to evaluate exactly what has changed and how privacy is affected. Further, it becomes time consuming when policies change often. The re-evaluation of a privacy policy can require significant decision making resources to determine if the revised policy is acceptable.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of sending potentially sensitive information. The method may be practiced, for example, in a computing environment. The method includes sending potentially sensitive information. Privacy expectation information is also sent specifying how the potentially sensitive information should be protected.

In another embodiment from the perspective of a receiving system in a computing environment, a method of receiving potentially sensitive information is illustrated. The method includes receiving potentially sensitive information. Privacy expectation information specifying how the potentially sensitive information should be protected is also received.

One embodiment is included as a computer readable medium having a data structure stored on the medium. The data structure is embodied in a security token. The data structure includes a first field, where the first filed includes potentially sensitive information. The data structure further includes a second field, where the second field includes privacy expectation information specifying how the potentially sensitive information should be protected.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an environment where information and privacy expectations for the information are sent;

FIG. 2 illustrates a method of sending information with privacy expectations; and

FIG. 3 illustrates a method of receiving information with privacy expectations.

### DETAILED DESCRIPTION

Embodiments herein may comprise a special purpose or general-purpose computer including various computer hardware, as discussed in greater detail below.

One embodiment illustrated herein provides functionality for allowing a client to indicate privacy policies that are acceptable to the client. The privacy policies can be indicated on a case by case basis by sending privacy expectations with the information to which the privacy expectations apply. Recipients of the information and the privacy expectations may be configured to honor privacy expectations. Alternatively, a recipient may indicate that the privacy expectations cannot be honored. In still other embodiments, a recipient will honor privacy expectations insofar as the recipient is configured to honor the privacy expectations. In still other embodiments, the privacy expectations can be embedded into tokens by the receiver and issued back to the client such that the privacy expectations can be included with authentication activities with other services.

Notably, some services may have legal restrictions preventing them from honoring certain privacy expectations. Domestic and international laws may require certain information to be stored and/or shared with particular entities. Banking industries have notorious reporting and data collection requirements that may prevent certain handling of data. As such, as previously noted, these organization may only honor privacy expectations only insofar as they are able, or not at all.

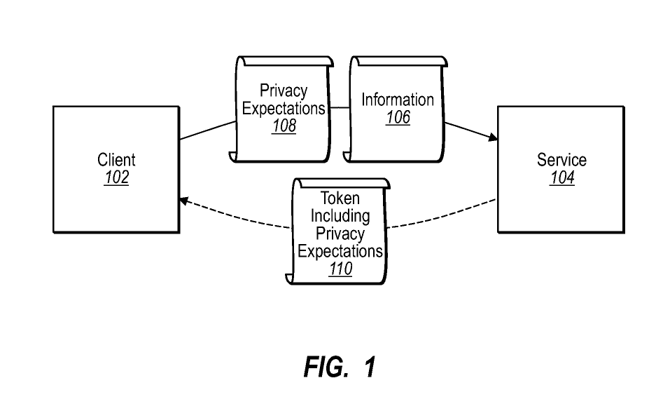

Reference is now made to FIG. 1, which illustrates one exemplary embodiment. FIG. 1 illustrates a client 102. FIG. 1 further illustrates a service 104. The service 104 may include functionality that the client 102 desires to access. In one embodiment, the service 104 may include token issuer services for issuing security and/or identification tokens to the client 102.

The client 102 sends information 106 to the service 104. In one embodiment, the information may be sensitive and/or personal information. For example, the information may be personal information or personally identifying information such as name, address, telephone number, age, gender, etc. While some examples of information are illustrated here, this enumeration should not be considered limiting on the information or types of information that can be expressed in the embodiments described herein.

FIG. 1 illustrates that the client 102 also sends privacy expectations 108 with the information 106. The privacy expectations 108 specify how the information 106 should be protected. For example, the privacy expectations may include one or more usage restrictions specifying how the information is to be used. For example, the usage restrictions may specify that the information is to be used for authentication purposes, for informational purposes, and/or specific purposes related to specific transactions or for use with specific applications.

Alternatively, the privacy expectations may include purpose information specifying the purpose of sending potentially sensitive information.

In yet another alternative embodiment, the privacy expectations may include confidentiality information specifying with whom the potentially sensitive information may be shared. For example, in one embodiment, the privacy expectations may specify that the information should not be shared. In other embodiments, the privacy expectations may specify that the information should only be shared with a given set of partners. In yet another embodiment, the privacy expectations may specify that the information should only be shared with partners of the entity receiving the information.

Notably, while embodiments may be described as alternative embodiments, it should be understood that embodiments may include more than one of the alternatives, or different alternatives altogether.

Embodiments may be implemented in various environments. For example, in one embodiment, the information 106 and the privacy expectations 108 may be performed in an application messaging exchange. Other embodiments may be implemented in a token request or authorization exchange.

Referring once again to FIG. 1, embodiments may be implemented where a token 10 including the privacy expectations 108 is returned to the client 102. Specifically, the information 106 may be passed in a token request procedure. A token that includes the information 106 and privacy expectation information 108 may be returned to the client 102. This token can then be used in other transactions that the client 102 may have with other services such that the other services are then aware of the privacy expectations 108 for the information 106. Embodiments may be implemented where the token is an identity token for identifying an entity. Alternatively, the token may be an authorization token to allow an entity to access functionality of a service.

In one embodiment the token 110 may include an indication of entity specific information that should be echoed for requestors to verify when using the token. Notably, entity specific information may be for any one of a number of different entities. For example, the information may apply to a user at a computer system. In another embodiment, the entity may apply to the computer system itself. Further still entities may be one of an organization, an individual, a computer system, other systems, etc. The specific enumeration of entities here should not be considered limiting of entities used in the embodiments that may be implemented.

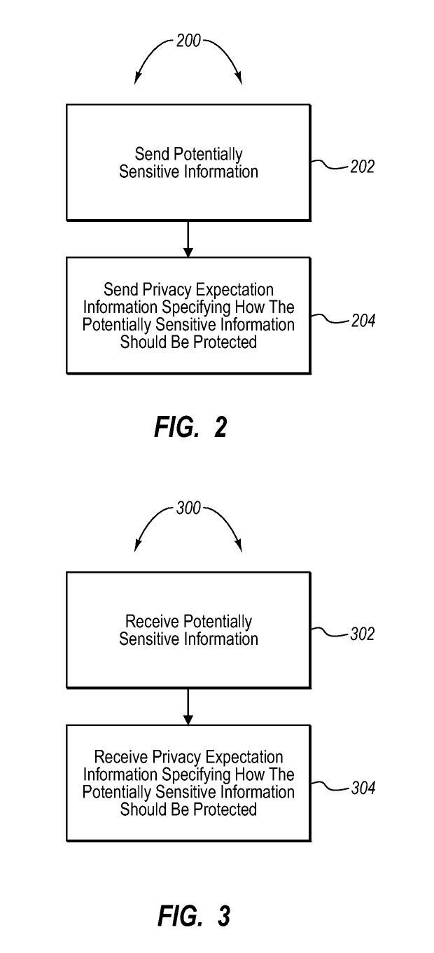

Referring now to FIG. 2, an exemplary method 200 is illustrated. The method 200 may be practiced in a computing environment, and includes various acts for sending potentially sensitive information. For example, FIG. 2 illustrates sending potentially sensitive information (act 202). As illustrated in FIG. 1, information 106 may be sent by a client 102 to a service 104. As explained previously, the information may be sensitive information. For example, in one embodiment, the information may be entity specific information. For example, the information may be a name, address, telephone number, age, etc. Other examples may include entity identifiers such as IP addresses, MAC addresses, serial numbers, or virtually any other information.

FIG. 2 further illustrates an act of sending privacy expectation information specifying how the potentially sensitive information should be protected (act 204). As discussed previously, the privacy expectation information may include for example one or more usage restrictions. In another embodiment, the privacy expectations may include purpose information specifying the purpose of sending the potentially sensitive information. In yet another embodiment, the privacy expectation information may include confidentiality information specifying with whom the potentially sensitive information may be shared.

The method 200 may be practiced in a number of embodiments as discussed previously. For example, the method 200 may be practiced in a token request procedure. In one embodiment, when the method 200 is practiced in a token request procedure, the method may further include receiving a token which includes the privacy expectation information. Such a token may be for example an identity token for identifying an entity, and/or an authorization token to allow the entity to access functionality of a service. Additionally, in one embodiment, the token may include an indication of entity specific information that should be echoed for requesters to verify when using the token.

While an example has been illustrated here where a method is used in a token request procedure, other environments may also be used. For example, the method 200 may be practiced in a simple application messaging exchange not including a token request procedure.

Referring now to FIG. 3, another embodiment illustrated. FIG. 3 illustrates a method 300 which may be practiced in a computing environment. The method 300 illustrates a method from the perspective of a service receiving privacy expectations and information. Illustratively, the method 300 includes receiving potentially sensitive information (act 302). As illustrated previously herein, information 106 may be received by a service 104 as demonstrated in FIG. 1. The information may be potentially sensitive information such as identity specific information, personal information, personally identifying information, or other sensitive information.

The method 300 illustrated in FIG. 3 further includes receiving privacy expectation information specifying how the potentially sensitive information should be protected (act 304). For example, as illustrated and FIG. 1, privacy expectations 108 are received with the information 106 at the service 104. As demonstrated in embodiments previously described herein, the privacy expectations may include, for example, one or more usage restrictions specifying how the potentially sensitive information is to be used, purpose information specifying the purpose of sending potentially sensitive information, and/or confidentiality information specifying with whom the potentially sensitive information may be shared.

Additionally, as illustrated previously herein, the information 106 and privacy expectations 108 may be used by a service 104 to provide a token 110 to the client 102. The token 10 may include privacy expectations embedded in the token 110. This allows the client 102 to pass the privacy expectations with the token 10 in other authentication procedures or service request procedures.

In one embodiment, the service 104 may consult service policy information to determine if the service 104 can honor all the privacy expectations 108. If the service 104 is able to honor the privacy expectations 108, the service 104 may notify the client 102 that the privacy expectations 108 will be honored. In some embodiments, the service 104 may not be able to honor the privacy expectations 108. The service can respond to the client 102 that the privacy expectations cannot be honored. The client 102 may then indicate to the service 104 either that the transaction should be completed in spite of the privacy expectations 108 not being able to be honored or alternatively, the client 102 may indicate that the transaction should be canceled and all information 106 previously sent to the service 104 discarded. In some embodiments, the service 104 may be able to honor some privacy expectations 108 while not being able to one or other privacy expectations. The service 104 can so indicate to the client 102. The client 102 can then determine whether not to precede with a given transaction.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Such computers may include, but are not limited to desktop computers, laptop computers, server systems, personal digital assistants, smart phones, embedded systems, etc. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of sending potentially sensitive information, the method comprising:
sending potentially sensitive information; and
sending privacy expectation information specifying how the potentially sensitive information should be protected.

2. The method of claim 1, wherein the method is practiced in a token request procedure.

3. The method of claim 2, further comprising receiving a token which includes the privacy expectation information.

4. The method of claim 3, wherein the token is an identity token for identifying an entity.

5. The method of claim 3, wherein the token is an authorization token to allow an entity to access functionality of a service.

6. The method of claim 3, wherein the token comprises an indication of entity specific information that should be echoed for requestors to verify when using the token.

7. The method of claim 1, wherein the method is practiced in an application messaging exchange.

8. The method of claim 1, wherein the privacy expectation information comprises one or more usage restrictions specifying how the potentially sensitive information is to be used.

9. The method of claim 1, wherein the privacy expectation information comprises purpose information specifying the purpose of sending potentially sensitive information.

10. The method of claim 1, wherein the privacy expectation information comprises confidentiality information specifying with whom the potentially sensitive information may be shared.

11. In a computing environment, a method of receiving potentially sensitive information, the method comprising:
receiving potentially sensitive information; and
receiving privacy expectation information specifying how the potentially sensitive information should be protected.

12. The method of claim 11, wherein the method is practiced in a token request procedure.

13. The method of claim 12, further comprising sending a token which includes the privacy expectation information.

14. The method of claim 13, wherein the token comprises an indication of entity specific information that should be echoed for requestors to verify when using the token.

15. The method of claim 11, wherein the method is practiced in an application messaging exchange.

16. The method of claim 11 wherein the privacy expectation information comprises one or more usage restrictions specifying how the potentially sensitive information is to be used.

17. The method of claim 11, wherein the privacy expectation information comprises purpose information specifying the purpose of sending potentially sensitive information.

18. The method of claim 11, wherein the privacy expectation information comprises confidentiality information specifying with whom the potentially sensitive information may be shared.

19. The method of claim 11, further comprising sending an indication specifying whether the privacy expectation information can be honored or not or if the privacy expectation information can be partially honored.

20. A computer readable medium having a data structure stored on the medium, the data structure being embodied in a security token, wherein the data structure comprises:
a first field, wherein the first filed comprises potentially sensitive information; and
a second field, wherein the second field comprises privacy expectation information specifying how the potentially sensitive information should be protected.
